(19) United States
(12) Patent Application Publication
(10) Pub. No.: US 2026/0175645 A1
(43) Pub. Date: Jun. 25, 2026

(54) COOLANT PUMP AND VALVE PROGNOSTIC STRATEGY

(71) Applicant: Ford Global Technologies, LLC, Dearborn, MI (US)

(72) Inventors: Da Li, Sammamish, WA (US); Sameera Ahmed, West Bloomfield, MI (US); Tobias Bischoff, Pasadena, CA (US); Richard Johnston, Camano Island, WA (US); Wei Ding, Northville, MI (US); Aaron James Vandiver, West Bloomfield Township, MI (US); Andrew McKay, Farmington Hills, MI (US); John Xiong, Holt, MI (US); Satheesh Kumar Chandran, Livonia, MI (US); Matteo Corbetta, Los Altos, CA (US)

(73) Assignee: Ford Global Technologies, LLC, Dearborn, MI (US)

(21) Appl. No.: 18/989,479

(22) Filed: Dec. 20, 2024

(51) Int. Cl. B60H 1/00; G05B 23/02

(52) U.S. Cl. CPC B60H 1/00978; G05B 23/0283

(57) ABSTRACT

A thermal control system is configured to transfer heat between refrigerant and coolant. A coolant distribution system includes one or more pumps and valves that are configured to control coolant flow to selectively heat and/or cool a vehicle cabin and/or vehicle components. Measured pump and valve operating parameters may be utilized to repeatedly update metrics that model the states of the pumps and/or valves. Anomalies may be detected by comparing the updated metrics to expected metrics. An alert concerning impending operating issue may be provided based, at least in part, on detected anomalies. A remaining useful life (RUL) of the pumps and/or valves may be determined based, at least in part, on detected anomalies.

### FIELD OF THE DISCLOSURE

The present disclosure generally relates to a vehicle thermal management system, and in particular to a system and method for predicting remaining useful life (RUL) of components of a coolant distribution system.

### BACKGROUND OF THE DISCLOSURE

Various thermal control arrangements have been developed to provide heating and/or cooling of vehicle cabins, high voltage (HV) batteries of electric vehicles, and the like.

### SUMMARY OF THE DISCLOSURE

An aspect of the present disclosure is a method of diagnosing a vehicle coolant distribution system, wherein the coolant distribution system includes a plurality of pumps that are driven utilizing electrical power and valves that are configured to control coolant flow whereby the coolant distribution system selectively heats and/or cools a vehicle cabin and/or vehicle components. The method includes measuring pump operating parameters associated with the pumps during operation of the coolant distribution system. The pump operating parameters may include one or more of the electricity consumption of each pump and a temperature of coolant flowing through a coolant loop associated with each pump. The method includes measuring valve operating parameters associated with the valves during operation of the coolant distribution system. The valve operating parameters may include one or more of valve response times, valve positions, and temperatures of coolant flowing through a coolant loop associated with each valve. The method may include utilizing the measured pump operating parameters and the measured valve operating parameters to repeatedly (e.g. sequentially) update metrics that model the states of the pumps and valves. The method may include detecting anomalies by comparing the updated metrics to expected metrics, wherein the expected metrics correspond to pumps and valves having acceptable operation according to predefined degradation criteria. The method may further include providing an alert concerning impending operating issues based, at least in part, on detected anomalies. The method may include predicting a remaining useful life (RUL) of the pumps and/or valves based, at least in part, on detected anomalies.

Embodiments of the first aspect of the present disclosure can include any one or a combination of the following features:
The coolant distribution system may be configured to operate in a plurality of operating modes, each operating mode having a unique coolant flow to heat and/or cool the vehicle cabin and/or vehicle components responsive to vehicle operating conditions. The measured pump operating parameters and measured valve operating parameters may be associated with an operating mode being used at the time the pump and valve operating parameters are measured.
The updated metrics and the expected metrics may correspond to operating modes whereby anomaly detection is based, at least in part, on mode-specific differences between the updated metrics and the expected metrics.
Each valve may control flow of coolant in an associated coolant loop. The valve metrics may comprise differences between expected and measured parameters, including: 1) differences between a nominal valve response time and a measured valve response time, and/or: 2) differences between a target valve position and a measured valve position, and/or: 3) differences between first and second coolant temperatures measured by first and second temperature sensors, respectively, at first and second locations of a coolant loop associated with each valve.
An anomaly may be detected if one or more differences between expected and measured parameters exceed predefined deviation thresholds.
Each pump may cause coolant to flow through an associated coolant loop, and the pump metrics may comprise differences between an electric current consumed by a selected pump and an electric current expected to be consumed by the selected pump when the pump is causing coolant to flow through the associated coolant loop.
An anomaly may be detected if one or more differences between an electric current consumed by a selected pump and an electric current expected to be consumed by the selected pump exceed a predefined threshold.
The pump metrics may comprise differences between measured pump revolutions per minute (RPM) and expected pump RPM.
An anomaly may be detected if one or more differences between a measured RPM of a selected pump and an expected RPM exceed a predefined threshold.
The RUL may be determined utilizing survival analysis and one or more similarity models to provide a degradation curve and a confidence interval to represent the wear state of one or more of the pumps and/or valves over time.
The degradation curve and confidence interval for each pump and each valve may be repeatedly updated over time using newly-measured pump operating parameters for each pump and newly-measured valve operating parameters for each valve. The RUL may be based, at least in part, on the updated degradation curve and updated confidence interval. An alert concerning impending operating issues may be provided if an RUL of a pump and/or an RUL of a valve falls below a predefined threshold.

Another aspect of the present disclosure is a vehicle comprising a refrigerant thermal management system that is configured to compress and expand refrigerant to heat and/or coolant utilizing one or more heat exchangers. The vehicle includes a coolant distribution system having a plurality of pumps that are driven utilizing electrical power, and valves that are configured to control coolant flow, whereby the coolant distribution system selectively heats and/or cools a vehicle cabin and/or vehicle components. The vehicle is configured to measure pump operating parameters associated with the pumps during operation of the coolant distribution system. The pump operating parameters may comprise one or more of electricity consumption of each pump and/or a temperature of coolant flowing through a coolant loop associated with each pump. The vehicle is configured to measure valve operating parameters associated with the valves during operation of the coolant distribution system. The valve operating parameters may comprise one or more of a valve response time and/or a valve position and/or a temperature of coolant flowing through a coolant loop associated with each valve. The vehicle may be configured to utilize the measured pump operating parameters and/or the measured valve operating parameters to repeatedly (e.g. sequentially) update metrics that model the states of the pumps and/or valves. The vehicle may also be configured to detect anomalies by comparing the updated metrics to expected metrics, wherein the expected metrics correspond to pumps and/or valves having acceptable operation according to predefined degradation criteria. The vehicle may also be configured to provide an alert concerning impending operating issues based, at least in part, on detected anomalies. The vehicle may also be configured to predict a remaining useful life (RUL) of the pumps and/or valves based, at least in part, on detected anomalies.

Embodiments of the second aspect of the present disclosure can include any one or a combination of the following features:
the coolant distribution system may be configured to operate in a plurality of operating modes, each operating mode having a unique coolant flow to heat and/or cool the vehicle cabin and/or vehicle components responsive to vehicle operating conditions. The measured pump operating parameters and measured valve operating parameters may be associated with an operating mode being used at the time the pump and valve operating parameters are measured.
The updated metrics and the expected metrics may correspond to operating modes whereby anomaly detection is based, at least in part, on mode-specific differences between the updated metrics and the expected metrics.
Each valve may control flow of coolant in an associated coolant loop. The valve metrics may comprise differences between expected and measured parameters, including: 1) differences between a nominal valve response time and a measured valve response time and/or: 2) differences between a target valve position and a measured valve position and/or: 3) differences between first and second coolant temperatures measured by first and second temperature sensors, respectively, at first and second locations of a coolant loop associated with each valve.
An anomaly may be detected if one or more differences between expected and measured parameters exceed predefined deviation thresholds.
Each pump may cause coolant to flow through an associated coolant loop. The pump metrics may comprise differences between an electric current consumed by a selected pump and an electric current expected to be consumed by the selected pump.
An anomaly may be detected if one or more differences between an electric current consumed by a selected pump and an electric current expected to be consumed by the selected pump exceed a predefined threshold.
The pump metrics may comprise differences between measured pump revolutions per minute (RPM) and expected pump RPM. An anomaly may be detected if one or more differences between a measured RPM of a selected pump and an expected RPM exceed a predefined threshold.

Another aspect of the present disclosure is a vehicle comprising a refrigerant thermal management system that is configured to compress and expand refrigerant to heat and/or coolant utilizing one or more heat exchangers. The vehicle includes a coolant distribution system including a plurality of pumps that are driven utilizing electrical power, and valves that are configured to control coolant flow, whereby the coolant distribution system selectively heats and/or cools a vehicle cabin and/or vehicle components. The vehicle is configured to measure pump operating parameters associated with the pumps during operation of the coolant distribution system. The vehicle is configured to measure valve operating parameters associated with the valves during operation of the coolant distribution system. The vehicle may be configured to utilize the measured pump operating parameters and/or the measured valve operating parameters to repeatedly (e.g. sequentially) update metrics that model the states of the pumps and/or valves. The vehicle may also be configured to detect anomalies by comparing the updated metrics to expected metrics, wherein the expected metrics correspond to pumps and/or valves that are operating properly according to predefined degradation criteria. The vehicle may also be configured to provide an alert concerning impending operating issues based, at least in part, on detected anomalies. The vehicle may also be configured to predict a remaining useful life (RUL) of the pumps and/or valves based, at least in part, on detected anomalies.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a schematic top plan view of a vehicle including a thermal control system according to an aspect of the present disclosure;

FIG. 2 is a block diagram showing pump and valve prognostics according to an aspect of the present disclosure;

FIG. 3 is a flow chart showing pump degradation detection according to an aspect of the present disclosure; and

FIG. 4 is a flow chart showing valve degradation detection according to an aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

The present illustrated embodiments reside primarily in combinations of method steps and apparatus components related to a vehicle thermal control system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element preceded by “comprises . . . a” or “includes . . . a” does not, without more constraints, preclude the existence of additional identical elements in the process, method, article, or apparatus that comprises the element.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

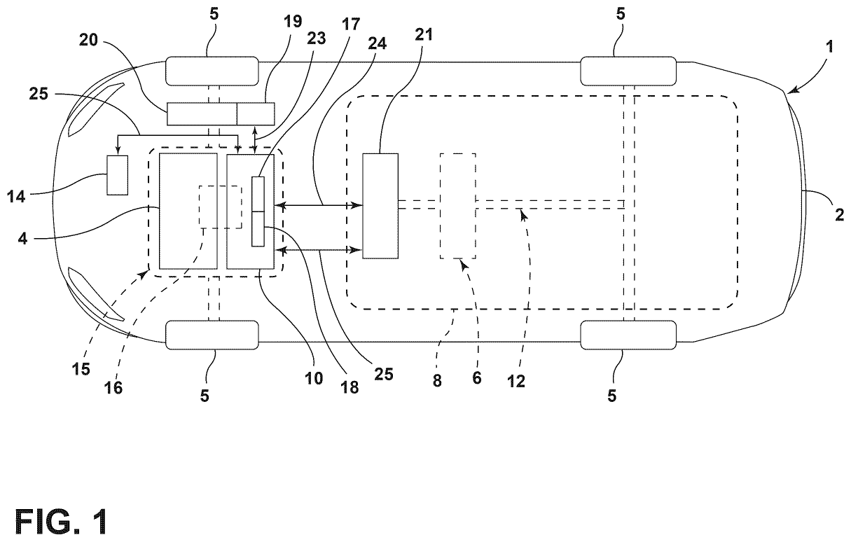

With reference to FIG. 1, a vehicle 1 according to an aspect of the present disclosure includes a body 2 and a vehicle thermal management or control system 15. The vehicle thermal management system 15 includes a refrigerant thermal management system or heat pump 4 and a coolant distribution system or module (CDM) 10. Heat pump 4 and CDM 10 may be thermally interconnected by one or more heat exchangers 16 to exchange heat between refrigerant of heat pump 4 and coolant of CDM 10. CDM 10 may include electrically-powered pumps 17 and valves 18 that are configured to cause coolant (e.g. liquid water and/or other substances) to flow through a heat exchanger 19 that is thermally coupled to a high voltage (HV) battery 20 to thereby heat and/or cool HV battery 20. The battery 20 may be configured to provide power to a vehicle drive system 12 to increase and/or decrease a speed of vehicle 1 by applying positive or negative to wheels 5 of vehicle 1. The CDM 10 may also be fluidly (thermally) coupled to a heat exchanger 21 that is configured to heat and/or cool cabin 8 of vehicle 1. Heat exchanger 21 may optionally comprise a heater core and a cooling core (“chiller”), and a fan or the like (not shown) may be configured to circulate air over the heat exchanger to heat and/or cool cabin 8. The CDM 10 may also be fluidly coupled to a low temperature radiator (LTR) 14 to exchange heat with ambient air flowing over the LTR 14. The arrows 23, 24, and 25 of FIG. 1 may represent a plurality of liquid lines or conduits forming coolant loops between CDM 10, LTR 14, heat exchanger 19, and cabin heat exchanger 21. It will be understood that each coolant loop may circulate coolant through heat exchangers of more than one of LTR 14, heat exchanger 19, and/or the cabin heat exchanger 21. The CDM 10 may include two, three, or more electrically-powered pumps 17 and two, three, or more electrically-powered valves 18 that control the flow of coolant to one or more vehicle components such as the LTR 14, heat exchanger 19, and/or cabin heat exchanger 21. Electrically-powered pumps 17 may be controlled utilizing a suitable control scheme (e.g. a duty cycle) to thereby control a volume and/or pressure of coolant pumped by the electrically-powered pumps 17.

The valves 18 may comprise three-position valves that are configured to control the flow of coolant through coolant loops 23-25 as required for different modes of operation. Valves 18 may comprise electrical actuators such as solenoids or electric motors that control the valve positions to thereby control flow of coolant through the valves as required to provide valve states corresponding to modes of the system. The modes may comprise heating and/or cooling modes. In general, in cooling modes, the LTR 14 discharges heat from a water-cooled condenser of heat pump 4 to ambient air. In heating modes, the LTR 14 absorbs heat from ambient air, which is then directed to one or more chillers (e.g. heat exchanger 19 of battery 20 and/or cabin heat exchanger 21). The modes provide for heating and/or cooling of various components that are thermally coupled to the system 15 by one or more coolant loops.

Examples of operating modes are shown in Table 1:

TABLE 1

| | Cabin Heat | Low Temperature | Battery Heat |
|---|---|---|---|
| | Exchanger (21) | Radiator (LTR) (14) | Exchanger (19) |
| Mode (Valve State) | Coolant Need | Coolant Need | Coolant Need |
| Service (No active | Flow | Flow | Flow |
| heating or cooling) | | | |
| Battery cooling | (None) | 70° C. | 10° C. |
| Cabin and battery | 0° C. | 70° C. | 10° C. |
| cooling independently | | | |
| Variation of cabin and | 0° C. | 70° C. | 0° C. |
| battery cooling | | | |
| independently | | | |
| All chillers cooling | 0° C. | 70° C. | Flow |
| cabin, battery | | | |
| self-circulating | | | |
| Cabin cooling, battery | 0° C. | (None) | 30° C. |
| passive cooling using | | | |
| LTR 14 to reduce | | | |
| power consumption/ | | | |
| increase range | | | |
| Dehumidification | CC: 0° C. | ?° C. | 20°? C |
| mode or heat recovery | HC: 70° C. | | |
| from power | | | |
| electronics and battery | | | |
| to heat cabin (with | | | |
| LTR bypassed) | | | |
| Battery heating with | 70° C. | Flow | 20° C. |
| electric resistance | | | |
| heater, cabin heating | | | |
| off if coolant | | | |
| temperature too low | | | |
| Cabin and battery | 70° C. | Flow | 20° C. |
| heating independently, | | | |
| without cabin | | | |
| dehumidification | | | |

The valve states (operating modes) of Table 1 are examples of coolant temperature requirements or targets for the cabin heat exchanger 21, LTR 14 and battery heat exchanger 19 for the listed modes. In general, a mode may be implemented based on operating conditions and/or user inputs. In Table 1, “Flow” generally designates coolant flow without a specific coolant temperature requirement, and “?” generally designates a coolant temperature that is determined during operation based, at least in part, on operating parameters of the vehicle and/or system 15 and/or the components that are thermally coupled to system 15. It will be understood that the modes of Table 1 are merely examples, and the present disclosure is not limited to these examples. Thermal control system 15 may be configured to provide virtually any number of modes with various flow and temperature controls as required for a particular application.

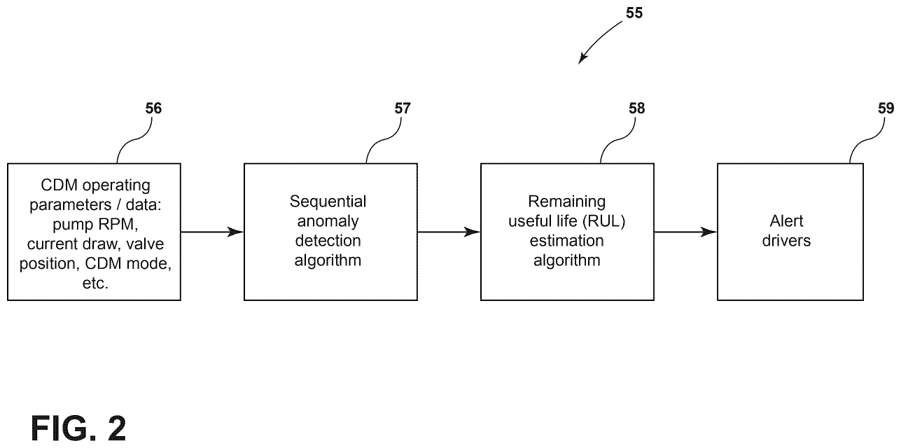

With further reference to FIG. 2, vehicle 1 may include a controller 6 that is operatively connected to the thermal control system 15. Controller 6 may be configured to measure operating parameters of pumps 17 and/or valves 18 during operation of CDM 10. As discussed in more detail below, the pump operating parameters may comprise electricity consumption of each pump and/or a temperature of coolant flowing through a coolant loop associated with each pump. The controller 6 may also be configured to measure valve operating parameters associated with valves 18 during operation of CDM 10. The valve operating parameters may comprise valve response time and/or valve position and/or a temperature or temperatures of coolant flowing through a coolant loop associated with each valve.

Referring again to FIG. 2, a workflow 55 to detect anomalies (e.g. operating issues or impending operating issues) associated with pumps 17 and/or valves 18 includes gathering CDM data at step 56. The CDM data may include pump revolutions per minute (RPMs), electrical current draw of the pumps 17, response time of valves 18, position of valves 18, and/or temperature of coolant upstream and/or downstream of valves 18. A sequential anomaly detection algorithm 57 determines if the measured operating parameters of the pumps 17 and/or valves 18 indicate that a pump or valve is degrading. A remaining useful life (RUL) estimation algorithm 58 determines if one or more pumps 17 and/or valves 19 have degraded in a manner that is likely to cause operating issues, and/or are likely to experience operating issues within a predefined time period. At 59, a user alert is provided if RUL estimation indicates that an estimated RUL meets predefined criteria (e.g. the RUL is below a threshold number of days or other length of time). In general, if a pump or valve may require service if it has degraded sufficiently and/or it is experiencing operating issues.

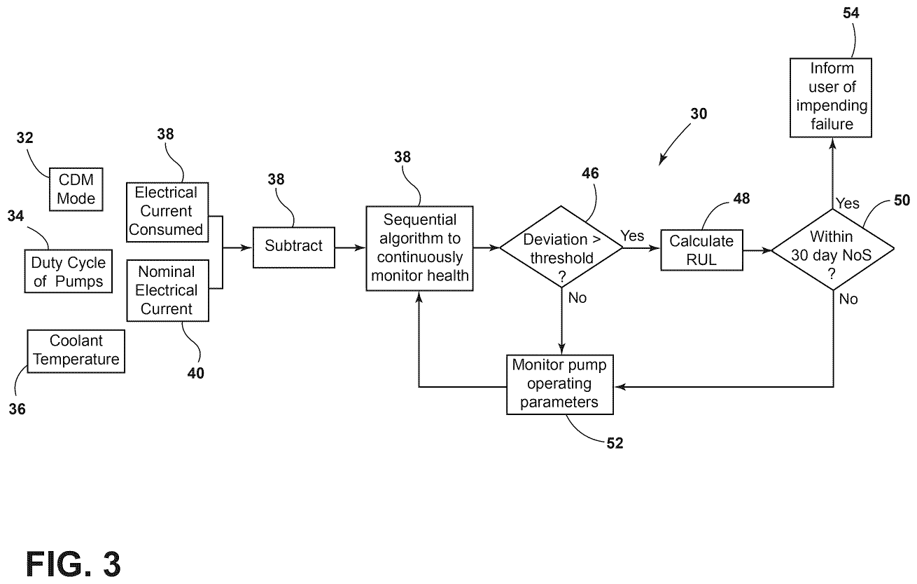

A process 34 for determining or predicting operating issues associated with pumps 17 is shown in FIG. 3. As discussed in more detail below, process 34 generally involves monitoring deviations of electrical current from an expected baseline. A sequential algorithm is used to monitor the latest measured electrical current values to monitor the health of the component (e.g. pumps 17). Calibrated values (expected electrical currents) for various operating conditions may be determined empirically by testing a properly operating (e.g. new) pump 17 in a vehicle under various operating conditions. The calibrated value (expected electrical current) can be used set threshold deviations of electrical current for various combinations of operating conditions. Thus, although some variations in electrical current about a baseline electrical current are expected, electrical current values that are outside of (above or below) the threshold deviations are not within the expected range. If the measured electrical current exceeds the threshold values (i.e. falls outside of the expected range) associated with the combination of operating conditions present at the time electrical current was measured, Remaining Useful Life (RUL) may then be estimated. If the RUL is less than 30 days (i.e. within 30 days of the time at which the RUL was determined), a user may be alerted of the issue and the user may also be advised to have the system serviced and/or take other action as may be necessary.

Referring again to FIG. 3, process 34 includes determining an electrical current consumed 38 and a nominal (expected) electrical current 40 utilizing a mode 32 of CDM 10, a duty cycle 34 of pumps 17 and a coolant temperature 36. In general, the coolant temperature 36 may comprise a temperature of coolant upstream and/or downstream of each pump 17. Coolant temperature 36 may comprise a plurality of temperatures measured at different locations in a coolant loop by a plurality of temperature sensors. Nominal current 40 may comprise an expected electrical current at a predefined voltage for a pump that is operating properly (e.g. a new pump) given CDM mode 32, duty cycle 34, and coolant temperature 36.

At step 38, the electrical current (or power) that is consumed by the pump 17 (i.e. measured electrical current) is compared to a nominal (expected) electrical current of the pumps by taking a difference (e.g. subtracting) at step 38. The differences are then utilized as inputs in a sequential algorithm 38 that continuously monitors the health of pumps 17 and/or valves 18. It will be understood that the measured electrical current 38 and nominal electrical current 40 may be continuously (repeatedly) updated, and differences may be continuously determined at step 38, and these differences may be repeatedly utilized by the algorithm 38.

Referring again to FIG. 3, at step 46, the system or process determines if deviations between measured and expected operating parameters exceed a predefined deviation threshold. If deviations do not exceed the threshold, the system continues to monitor pump operating parameters at 52 and may return to step 38. However, if the deviation threshold is exceeded at 46, a remaining useful life (RUL) is calculated at 48, and the process then proceeds to step 50. At step 50, if the RUL is within a 30-day Notification of Service (NoS) at step 50, a user is informed of impending or potential operating issues at step 54. Restated, if the Remaining Useful Life is equal to or less than 30 days at step 50, the user is notified and directed to service the component. However, if the RUL is not within a 30-day NoS at step 50 (i.e. the RUL is greater than 30 days), a user notification is not required the system continues to monitor pump operating parameters at step 52. It will be understood that 30 days is merely an example of a suitable predefined RUL that may be used to determine if user notification is required, and other RUL criteria may be utilized as required for a particular component or application.

It will be understood that the pump operating parameters that are measured and compared to expected operating parameters may include numerous variables such as pump RPM, pump heat, the temperature of the pump itself (e.g. the pump housing) and/or other operating parameters in addition to coolant temperatures, measured electrical current 38 and expected (nominal) electrical current 40.

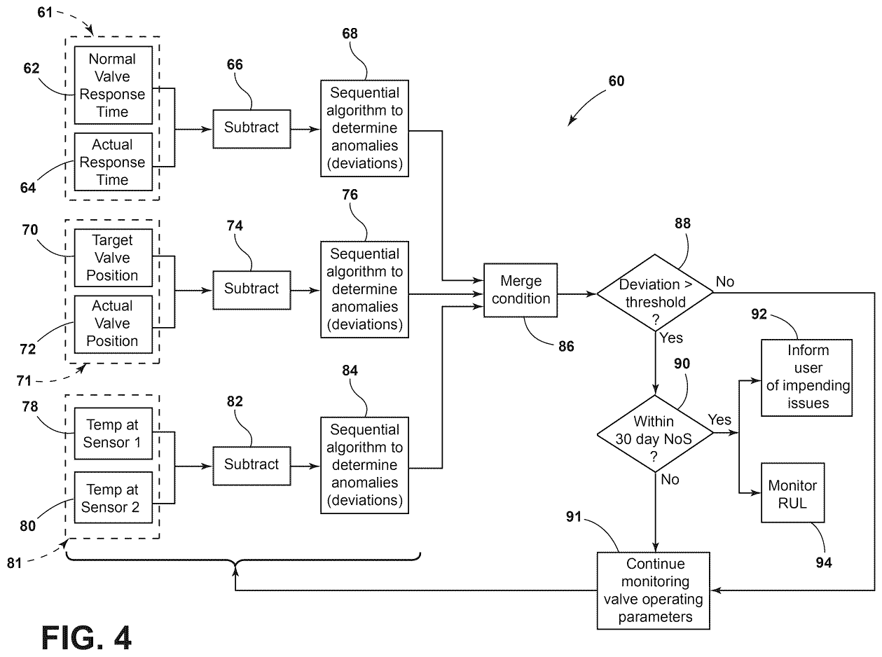

With further reference to FIG. 4, a system or process 60 for detecting degradation of valves 18 may include measuring operating parameters such as valve response time 61, valve position 71, and coolant temperature 81. Specifically, a difference between a normal or expected valve response time 62 and an actual or measured valve response time 64 may be determined by subtraction as shown at step 66. The differences determined at step 66 are utilized in a sequential algorithm 68 to determine anomalies (e.g. differences between expected and actual valve response times). In general, valve response time may comprise a time lapse between a request for a valve to shift to a desired position and a measured time for a valve to reach the desired (target) position. In general, any deviation exceeding a predefined threshold may be recorded. Differences between measured and expected valve response times may indicate that a valve actuator is not operating properly, and changes in the differences may signal degradation of a valve actuator or other operating issues.

Similarly, a difference between a target or expected valve position 70 and an actual or measured valve position 72 can be determined by subtraction 74, and the differences determined at step 74 can be utilized in a sequential algorithm 76 to determine if anomalies exist. Deviations between target and actual (measured) valve positions may be monitored (repeatedly determined) to determine if valve actuator issues are present. Differences between measured and target valve positions may indicate that a valve actuator is not operating properly, and changes in the differences may signal degradation or other operating issues.

Coolant temperature can also be utilized to determine if the valves 18 are operating properly or degrading. Specifically, a difference between a temperature at a first sensor 78 and a temperature at a second sensor 82 and the differences can then be utilized in a sequential algorithm 84 to determine anomalies. In general, a first temperature 78 can be measured by a first temperature sensor at a first location in a coolant loop (e.g. one of coolant loops 23-25, FIG. 1), and a second temperature 80 can be measured by a second temperature sensor that is at a different location in the coolant loop. Deviations in temperature at different locations within a single coolant loop may be monitored to identify potential degradation of performance or other operating issues. Deviation from nominal heat loss/gain may be an indicator that one or more components (e.g. valve actuators) are degrading. It will be understood that temperature differences between temperature sensors 78 and 82 may be monitored over time, and differences in temperature readings from each sensor 78 and 82 may be monitored over time to determine if operating issues are occurring or are likely to occur in the near future (e.g. within 30 days).

At step 86, the results of sequential algorithms 68, 76, and 84 are merged, and deviations are compared to predefined threshold values at step 88. If deviations do not exceed predefined thresholds at 88, the system continues to monitor valve operating parameters at 91. However, if one or more deviation thresholds are exceeded at 88, the process continues to step 90, and the system determines if it is within a 30-day NoS. If it is not within a 30-day NoS at 90, the system continues to step 91, and the system continues to monitor valve operating parameters. However, if it is within the 30-day NoS at step 90, a user is informed of impending issues at 92 (e.g. operating issues that are predicted to occur within 30 days), and the system continues to monitor RUL at 94.

Vehicle controller 6 may include a data collection module that continuously monitors and gathers performance indicators for pumps 17 and valves 18. The metrics or variables may include the operating mode of the CDM 10, target (expected) and/or measured voltage supplied to pumps 17, target (expected) and/or measured electrical current supplied to electric pumps 17, commanded (target or expected) and/or measured RPM of pumps 17, target (expected) and/or measured pump temperatures, total running hours, target (expected) and/or measured valve positions, target (expected) and/or measured valve response time, and/or target (expected) and/or measured coolant temperature. These parameters may be sourced from a vehicle's Control Area Network (CAN) signals to provide accurate real-time data acquisition. By collecting a comprehensive set of performance indicators, the data collection module may enable precise monitoring and analysis of the system's operational health and efficiency.

The sequential anomaly detection algorithm may be configured to continuously detect anomalies (deviations) and monitor the health of components such as pumps and/or valves. Using the data gathered from the data collection module, the algorithm sequentially updates a health metric that models the state of the component(s) over time. By detecting deviations from expected behaviors, the algorithm identifies anomalies indicative of a component degrading and/or wearing out. The sequential anomaly detection algorithm may dynamically adjust its models to account for gradual shifts in a component's state, allowing for early detection of potential issues.

The remaining useful life (RUL) estimation algorithm may employ a hybrid approach, which may involve combining survival analysis and similarly models to estimate the RUL of pumps 17 and/or valves 18. The RUL estimation algorithm may construct a degradation curve, along with a credible interval (or confidence interval), to represent the health of one or more components over time. The algorithm continuously updates the health indicator as the component operates and new data is collected. By repeatedly updating the degradation curve and confidence levels, the algorithm provides accurate and dynamic RUL predictions, thereby enabling proactive maintenance and minimizing unexpected operational issues (e.g. operation of a component that does not satisfy predefined acceptance criteria with regards to operational performance of a component).

To determine whether there is an anomaly in the signals from the pumps and/or valves, decision thresholds may be determined for each component. This process may involve recording the signals from components functioning optimally to establish a baseline, and from components that have experienced degradation. The latter can be acquired by subjecting the component to an extended run-to-failure process, conducting accelerated degradation tests, or implementing fault injection methods to simulate varying degrees of degradation. To establish a baseline, the identified signals can be collected from a properly functioning thermal control system 15 in each mode under different operational conditions (e.g., varying external temperatures, towing scenarios). Data processing approaches (e.g., low-pass filtering), may be applied to refine the quality of the collected data. A range of degradation scenarios may be identified by considering component specifications and other inputs. Controlled faults in hardware and/or software components may be introduced, and correlations between the degradation induced during testing and usage encountered in “real-world” driving conditions may be established. This may provide a set of signals that correspond to various levels of pump and/or valve degradation. Thresholds for anomaly detection may be determined using an appropriate process such as Expected Utility Theory (EUT), which takes into account tradeoffs between True Positive Rate (TPR) and False Positive Rate (FPR).

Anomalies may be detected using machine learning models and/or rule-based methods. If a pump or valve operates below an acceptance threshold determined by machine learning models and/or rule-based methods, it may be considered as having operational issues (e.g. degraded performance) according to predefined criteria. The remaining useful life (RUL) may be estimated using, for example, a correlation of its performance and expected lifespan.

An appropriate estimation model for determining RUL can be applied depending on data availability. Examples of estimation models include a Survival Model, a Degradation Model, and a Similarity Model. It will be understood that these models are generally known. The Survival Model may be utilized if failure time is the only available data. If additional data is available (e.g. degradation information and run-to-failure data) Degradation and/or Similarity models may be utilized for RUL estimation.

Survival Model: The survival model estimates RUL based solely on component life data, which can be obtained from lab testing and/or observations of operating issues that may require replacement or repair. Using this data, a probability density function (PDF) is constructed to represent the distribution of times associated with operational issues from a population. The expected value of the PDF corresponds to the total useful life of the component. Subtracting the current operating time from the total useful life yields the RUL. In a compact mathematical form:

$$R U L = \frac{1}{R ( {t}_{0} )} {\int }_{{t}_{0}}^{∞} R ( t ) d t \qquad ( 1 )$$

Where:
R(t) is the Reliability function which can be modeled using a Weibull distribution, t₀ is the current operating time. The RUL estimate obtained from this model represents the expected lifetime for the entire population of components. The estimate is not tailored to each specific component, and it does not take into account the unique degradation curve of a specific component of interest.

Degradation Model: The degradation model may be used when data concerning time to operational issues is not available (e.g. actual component life data is not available) but knowledge of a threshold that should not be crossed is available. In this case, a degradation model can be fitted to the condition indicator using the degradation data from the component to predict how the condition indicator will change in the future. It is possible to statistically estimate how much time there will be until the condition indicator crosses the threshold. The uncertainties in degradation tend to increase over time, which in turn tends to widen the confidence interval of the model.

The degradation model (method) offers a degree of customized RUL prediction for a specific component, but it may not be as finely tailored as the similarity model, which may requires higher resolution data concerning run time to operational issues run-to-failure from the population.

Similarity Model: If sufficient data is available from a population of components, including data concerning the healthy state, degradation, and time until operational issues are encountered, the similarity model can be used to estimate RUL. This method compares the degradation curve of the component to the degradation curves of similar components with known failure times. By identifying the most similar components, the similarity model can estimate the RUL of the component of interest.

In the similarity model approach, data reduction can be performed to identify trendable data (some sensor data may not reflect degradation) and then combine them to compute condition indicators. A similarity model can be trained using run-to-operational issues trajectories of the population. By identifying the closest N profiles to a current component, the RUL can be estimated using the time to operational issues of those closest neighbors. To evaluate prediction error, a train-test split can be performed. The EUL prediction may be continuously updated as the closest profiles change over time.

A Gaussian Process (GP) regression may be used for fitting pump and valve survival or similarity models to estimate their RUL. In this approach, the dependent variable is the component condition indicator, such as pump current draw, RPM, and valve travel time, while the independent variable is the level of usage or operating time. The GP model may construct a degradation curve along with its credible interval to represent the component's health as it functions. Bayesian updating may be used to continually update the mean and covariance of the health indicator as the component is utilized and new data is gathered. This approach enables the degradation curve and confidence levels to be updated when extrapolating it to determine the RUL of the component(s).

Controller 6 of vehicle 1 may optionally include a user alert module. For example, when the RUL of a component falls below a pre-determined threshold (e.g. 1 day, 5 days, 10 days, 30 days, 60 days, 90 days or more), the user alert module may be activated. The user alert module may be configured to promptly notify users through an app that may be associated with one or more remote devices (e.g. smart phones). The alert may comprise text, audio, or graphics (e.g. on a screen in cabin 8) that advises users to bring vehicle 1 in for maintenance or inspection to prevent unexpected issues.

It is to be understood that variations and modifications can be made to the aforementioned disclosure without departing from the concepts of the present disclosure, and further it is to be understood that such concepts are intended to be covered by the following claims unless these claims by their language expressly state otherwise.

What is claimed is:

1. A method of diagnosing a vehicle coolant distribution system, the vehicle coolant distribution system including a plurality of pumps that are driven utilizing electrical power and a plurality of valves that are configured to control coolant flow, whereby the coolant distribution system selectively heats and/or cools a vehicle cabin and/or vehicle components, the method comprising:
measuring pump operating parameters associated with the pumps during operation of the coolant distribution system;
wherein the pump operating parameters comprise electricity consumption of each pump and a temperature of coolant flowing through a coolant loop associated with each pump;
measuring valve operating parameters associated with the valves during operation of the coolant distribution system;
wherein the valve operating parameters comprise valve response times, valve positions, and temperature of coolant flowing through a coolant loop associated with each valve;
utilizing the measured pump operating parameters and the measured valve operating parameters to sequentially update metrics that model the states of the pumps and valves;
detecting anomalies by comparing the updated metrics to expected metrics, wherein the expected metrics correspond to pumps and valves having acceptable operation according to predefined degradation criteria; and
providing an alert concerning impending operating issues based, at least in part, on detected anomalies and/or a predicted remaining useful life (RUL) of the pumps and valves wherein the predicted RUL is based, at least in part, on detected anomalies.

2. The method of claim 1, wherein:
the coolant distribution system is configured to operate in a plurality of operating modes, each operating mode having a unique coolant flow to heat and/or cool the vehicle cabin and/or vehicle components responsive to vehicle operating conditions and/or user requests;
the measured pump operating parameters and measured valve operating parameters are associated with an operating mode being used at the time the pump and valve operating parameters were measured.

3. The method of claim 2, wherein:
the updated metrics and the expected metrics correspond to operating modes whereby anomaly detection is based, at least in part, on mode-specific differences between the updated metrics and the expected metrics.

4. The method of claim 1, wherein:
each valve controls flow of coolant in an associated coolant loop;
the valve metrics comprise differences between expected and measured parameters, including: 1) differences between a nominal valve response time and a measured valve response time and/or: 2) differences between a target valve position and a measured valve position and/or: 3) differences between first and second coolant temperatures measured by first and second temperature sensors, respectively, at first and second locations of a coolant loop associated with each valve.

5. The method of claim 4, wherein:
an anomaly is detected if one or more differences between expected and measured parameters exceed predefined deviation thresholds.

6. The method of claim 5, wherein:
each pump causes coolant to flow through an associated coolant loop;
the pump metrics comprise differences between an electric current consumed by a selected pump and an electric current expected to be consumed by the selected pump when the pump is causing coolant to flow through the associated coolant loop.

7. The method of claim 6, wherein:
an anomaly is detected if one or more differences between an electric current consumed by a selected pump and an electric current expected to be consumed by the selected pump exceed a predefined threshold.

8. The method of claim 6, wherein:
the pump metrics comprise differences between measured pump revolutions per minute (RPM) when the pump is causing coolant to flow through the associated coolant loop and expected pump RPM required to cause coolant to flow through the associated coolant loop.

9. The method of claim 8, wherein:
an anomaly is detected if one or more differences between a measured RPM of a selected pump and an expected RPM exceed a predefined threshold.

10. The method of claim 1, wherein:
the RUL is determined utilizing survival analysis and one or more similarity models to provide a degradation curve and a confidence interval to represent a wear state of one or more of the pumps and/or valves over time.

11. The method of claim 10, wherein:
the degradation curve and confidence interval for each pump and each valve are updated repeatedly using newly-measured pump operating parameters for each pump and newly-measured valve operating parameters for each valve;
the RUL for each pump and each valve is updated repeatedly based, at least in part, on the updated degradation curve and the updated confidence interval; and
an alert concerning impending operating issues is provided if an RUL of a pump and/or an RUL of a valve falls below a predefined threshold.

12. A vehicle comprising:
a refrigerant thermal management system that is configured to compress and expand refrigerant to heat and/or cool coolant utilizing one or more heat exchangers;
a coolant distribution system including a plurality of pumps that are driven utilizing electrical power and valves that are configured to control coolant flow, whereby the coolant distribution system selectively heats and/or cools a vehicle cabin and/or vehicle components;
wherein the vehicle is configured to:
measure pump operating parameters associated with the pumps during operation of the coolant distribution system, wherein the pump operating parameters comprise the electricity consumption of each pump and a temperature of coolant flowing through a coolant loop associated with each pump;
measure valve operating parameters associated with the valves during operation of the coolant distribution system, wherein the valve operating parameters comprise a valve response time, a valve position, and a temperature of coolant flowing through a coolant loop associated with each valve;
utilize the measured pump operating parameters and the measured valve operating parameters to repeatedly update metrics that model the states of the pumps and valves;
detect anomalies by comparing the updated metrics to the expected metrics, wherein the expected metrics correspond to pumps and valves having acceptable operation according to predefined degradation criteria; and
provide an alert concerning impending operating issues based, at least in part, on detected anomalies and/or a predicted remaining useful life (RUL) of the pumps and valves wherein the predicted RUL is based, at least in part, on detected anomalies.

13. The vehicle of claim 12, wherein:
the coolant distribution system is configured to operate in a plurality of operating modes, each operating mode having a unique coolant flow to heat and/or cool the vehicle cabin and/or vehicle components responsive to vehicle operating conditions and/or user unputs;
the measured pump operating parameters and measured valve operating parameters are associated with an operating mode being used at the time the pump and valve operating parameters are measured.

14. The vehicle of claim 13, wherein:
the updated metrics and the expected metrics correspond to predefined operating modes whereby anomaly detection is based, at least in part, on mode-specific differences between the updated metrics and the expected metrics.

15. The method of claim 12, wherein:
each valve controls flow of coolant in an associated coolant loop;
the valve metrics comprise differences between expected and measured parameters, including: 1) differences between a nominal valve response time and a measured valve response time and/or: 2) differences between a target valve position and a measured valve position and/or: 3) differences between first and second coolant temperatures measured by first and second temperature sensors, respectively, at first and second locations of coolant loops associated the valves.

16. The vehicle of claim 15, wherein:
an anomaly is detected if one or more differences between expected and measured parameters exceed predefined deviation thresholds.

17. The vehicle of claim 16, wherein:
each pump causes coolant to flow through an associated coolant loop;
the pump metrics comprise differences between an electric current consumed by a selected pump and an electric current expected to be consumed by the selected pump when the pump is causing coolant to flow through the associated coolant loop.

18. The vehicle of claim 17, wherein:
an anomaly is detected if one or more differences between an electric current consumed by a selected pump and an electric current expected to be consumed by the selected pump exceed a predefined threshold.

19. The vehicle of claim 17, wherein:
the pump metrics comprise differences between measured pump revolutions per minute (RPM) and expected pump RPM; and
an anomaly is detected if one or more differences between a measured RPM of a selected pump and an expected RPM exceed a predefined threshold.

20. A vehicle comprising:
a refrigerant thermal management system that is configured to compress and expand refrigerant to heat and/or cool coolant utilizing one or more heat exchangers;
a coolant distribution system including a plurality of pumps that are driven utilizing electrical power and valves that are configured to control coolant flow, whereby the coolant distribution system selectively heats and/or cools a vehicle cabin and/or vehicle components;
wherein the vehicle is configured to:
measure pump operating parameters associated with the pumps during operation of the coolant distribution system;
measure valve operating parameters associated with the valves during operation of the coolant distribution system;
utilize the measured pump operating parameters and the measured valve operating parameters to repeatedly update metrics that model the states of the pumps and valves;
detect anomalies by comparing the updated metrics to expected metrics, wherein the expected metrics correspond to pumps and valves that are operating properly according to predefined degradation criteria; and
providing an alert concerning impending operating issues based, at least in part, on detected anomalies and/or a predicted remaining useful life (RUL) of the pumps and valves wherein the predicted RUL is based, at least in part, on detected anomalies.
